(19) United States
(12) Patent Application Publication
(10) Pub. No.: US 2025/0213091 A1
(43) Pub. Date: Jul. 3, 2025

(54) ROBOT CLEANER AND METHOD FOR CONTROLLING THEREOF

(71) Applicant: SAMSUNG ELECTRONICS CO., LTD., Suwon-si (KR)

(72) Inventors: Hyungmin SON, Suwon-si (KR); Youngdae KO, Suwon-si (KR); Daesoo KIM, Suwon-si (KR); Jinho KIM, Suwon-si (KR); Jinsoo JEONG, Suwon-si (KR); Heeseung CHOI, Suwon-si (KR)

(73) Assignee: SAMSUNG ELECTRONICS CO., LTD., Suwon-si (KR)

(21) Appl. No.: 19/085,530

(22) Filed: Mar. 20, 2025

Related U.S. Application Data
(63) Continuation of application No. PCT/KR2024/016481, filed on Oct. 25, 2024.

(30) Foreign Application Priority Data
Dec. 11, 2023 (KR) 10-2023-0178734

(51) Int. Cl. A47L 11/40; G05D 1/241; G05D 1/246; G05D 1/622; G05D 105/10

(52) U.S. Cl. CPC A47L 11/4069; A47L 11/4002; A47L 11/4011; A47L 11/4038; A47L 11/4061; A47L 11/4072; G05D 1/241; G05D 1/2462; G05D 1/622; A47L 2201/04; G05D 2105/10

(57) ABSTRACT

A robot cleaner includes: a main body; a driving wheel disposed on the bottom of the main body and configured to move the main body; a mopping device disposed on the bottom of the main body; and a rotation device including: a bridge connected to the mopping device, and a first motor configured to rotate the bridge for the mopping device such that the mopping device is moved to one from among a first position and a second position, wherein the mopping device is disposed on the bottom of the main body based on the mopping device being in the first position, and the mopping device protrudes outward from the main body based on the mopping device being in the second position.

### CROSS-REFERENCE TO RELATED APPLICATIONS

This application is a by-pass continuation application of International Application No. PCT/KR2024/016481, filed on Oct. 25, 2024, which is based on and claims priority to Korean Patent Application No. 10-2023-0178734, filed on Dec. 11, 2023, in the Korean Intellectual Property Office, the disclosures of which are incorporated by reference herein in their entireties.

### BACKGROUND

### 1. Field

The present disclosure relates to a robot cleaner and a method for controlling thereof.

### 2. Description of Related Art

Robotic technology is being used in various fields to replace human labor in accordance with the development of technology. Robots have been used in factories, construction sites, medical fields, aerospace fields, or the like, and its field of use has been recently expanded further. Accordingly, robots that may be used in homes are being developed. A representative one among these robots may include a robot cleaner.

A conventional vacuum cleaner performs cleaning by a human manually sweeping the vacuum cleaner over a region to be cleaned. However, as a robot cleaner is developed and utilized, the robot cleaner may perform dry and wet cleaning of the cleaning region on its own.

However, a conventional robot cleaner is unable to clean a corresponding space in case that the robot cleaner is unable to enter a lower space of furniture such as a bed or a sofa, for example.

### SUMMARY

According to an aspect of the disclosure, a robot cleaner includes: a main body; a driving wheel disposed on the bottom of the main body and configured to move the main body; a mopping device disposed on the bottom of the main body; and a rotation device including: a bridge connected to the mopping device, and a first motor configured to rotate the bridge for the mopping device such that the mopping device is moved to one from among a first position and a second position, wherein the mopping device is disposed on the bottom of the main body based on the mopping device being in the first position, and the mopping device protrudes outward from the main body based on the mopping device being in the second position.

The mopping device may include: a mopping pad; a second motor configured to rotate the mopping pad; and at least one sensor. The robot cleaner may further include: one or more processors; and memory storing instructions, that when executed by the one or more processors, cause the robot cleaner to control the first motor to move the mopping device to one from among the first position and the second position based on a sensing value of the at least one sensor.

The main body may have a circular shape, the mopping pad may be disposed inside an outer diameter of the main body based on the mopping device being in the first position, and the mopping pad may protrude from the outer diameter of the main body to the outside of the main body within a predetermined range based on the mopping device being in the second position.

The rotation device may further include a passive joint disposed on the bridge, and the one or more processors may be configured to execute the instructions to cause the robot cleaner to: change a position of the mopping device based on a magnitude of an external force being applied to the mopping pad while the mopping device is in the second position; and return the mopping device to the second position based on the external force dissipating.

The at least one sensor may include a contact detection sensor disposed along an outer circumference of the mopping pad, the contact detection sensor may be configured to detect contact between the mopping pad and a surrounding object, and a first diameter of the contact detection sensor may be larger than a second diameter of the mopping pad.

The at least one sensor may include a distance detection sensor configured to recognize a surrounding object.

The one or more processors may be configured to execute the instructions to cause the robot cleaner to activate the distance detection sensor based on the mopping device being moved to the second position.

The one or more processors may be configured to execute the instructions to cause the robot cleaner to: determine, based on the mopping device being in the second position, a measured distance from a first surrounding object positioned on a travel path of the robot cleaner in a travel direction of the robot cleaner to an outer circumference of the mopping pad based on a first sensing value of the distance detection sensor; and control the first motor to rotate the mopping device toward the first position based on the measured distance being within a predetermined range.

The predetermined range may include a predetermined duration range, the one or more processors may be configured to execute the instructions to cause the robot cleaner to control the first motor to rotate the mopping device toward the first position based on a calculated duration being within the predetermined duration range, and the calculated duration may be determined based on dividing the measured distance by a traveling speed of the robot cleaner.

The one or more processors may be configured to execute the instructions to cause the robot cleaner to: generate a map for a space where the robot cleaner is disposed based on at least one second sensing value of a spatial recognition sensor among the at least one sensor; store the map in the memory; and determine the travel path based on the generated map.

The one or more processors may be configured to execute the instructions to cause the robot cleaner to generate the map based on simultaneous localization and mapping (SLAM).

The one or more processors may be configured to execute the instructions to cause the robot cleaner to: determine a measured separation height between the ground and a bottom surface of a first surrounding object disposed on a travel path of the mopping device based on a first sensing value of the distance detection sensor; and control the first motor to rotate the mopping device toward the first position based on the measured separation height being within a predetermined range.

According to an aspect of the disclosure, a method for controlling a robot cleaner which includes a mopping device, includes: performing cleaning based on the robot cleaner traveling through a space by disposing the mopping device on the bottom of a main body of the robot cleaner; rotating the mopping device to protrude outward from the main body and performing the cleaning with the mopping device based on the robot cleaner reaching a determined position in the space; and determining a detection result of a collision or a collision probability between a surrounding object and the mopping device based on a sensing value of at least one sensor disposed in the mopping device, and changing a position of the mopping device based on the detection result.

The mopping device may include a mopping pad, a second motor configured to rotate the mopping pad, and the at least one sensor. The mopping device may be connected to the main body by a rotation device. The rotation device may include a bridge connected to the mopping device and a first motor configured to rotate the bridge. The performing the cleaning may include driving the first motor such that the mopping device protrudes outward from the main body.

The determining the detection result may include: detecting the collision based on a first sensing value of a contact detection sensor among the at least one sensor; and moving the mopping device to be lower than the main body based on the collision being detected.

The determining the detection result may include: determining a detected distance between the surrounding object and the mopping device based on a first sensing value of a distance detection sensor among the at least one sensor; and moving the mopping device to be lower than the main body based on a value of the detected distance being within a predetermined range.

The determining the detection result may include: determining a measured separation height between the ground and a bottom surface of a first surrounding object disposed on a travel path of the mopping device based on a first sensing value of a distance detection sensor among the at least one sensor; and moving the mopping device to be lower than the main body based on the measured separation height being within a predetermined range.

The method may further include deactivating the at least one sensor based on the mopping device being disposed on the bottom of the main body, and activating the at least one sensor based on the mopping device protruding outward from the main body.

The method may further include, based on the mopping device being moved to be lower than the main body, moving the mopping device to a prior position before being moved based on a calculated value indicating the robot cleaner has passed the first surrounding object, wherein the calculated value is based on a second sensing value of the distance detection sensor or a third sensing value of a spatial recognition sensor among the at least one sensor.

According to an aspect of the disclosure, a non-transitory computer-readable recording medium having instructions recorded thereon, that, when executed by one or more processors of a robot cleaner including a mopping device, cause the robot cleaner to: perform cleaning based on the robot cleaner traveling through a space by disposing the mopping device on the bottom of a main body of the robot cleaner; rotate the mopping device to protrude outward from the main body and performing the cleaning with the mopping device based on the robot cleaner reaching a determined position in the space; and determine a detection result of a collision or a collision probability between a surrounding object and the mopping device based on a sensing value of at least one sensor disposed in the mopping device, and changing a position of the mopping device based on the detection result.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a perspective view of a robot cleaner according to one or more embodiments.

FIG. 2 is a bottom view of the robot cleaner according to one or more embodiments.

FIG. 3 is a perspective view of the robot cleaner except for its housing according to one or more embodiments.

FIGS. 4 and 5 are views for explaining a position change of a mopping pad in the robot cleaner according to one or more embodiments.

FIG. 6 is a view for explaining a passive joint of the robot cleaner according to one or more embodiments.

FIG. 7 is an exploded perspective view of the passive joint of the robot cleaner according to one or more embodiments.

FIG. 8 is a view for explaining a position change of a mopping device by the passive joint of the robot cleaner according to one or more embodiments.

FIG. 9 is a block diagram for explaining a cleaning operation of the robot cleaner according to one or more embodiments.

FIG. 10 is a view showing a contact detection sensor of the robot cleaner according to one or more embodiments.

FIG. 11 is a view for explaining a distance detection sensor of the robot cleaner according to one or more embodiments.

FIG. 12 is a flowchart for explaining the position change of the mopping device according to one or more embodiments.

FIG. 13 is a view for explaining the position change of the mopping device by the contact detection sensor of the robot cleaner according to one or more embodiments.

FIG. 14 is a view for explaining the position change of the mopping device by the distance detection sensor of the robot cleaner according to one or more embodiments.

### DETAILED DESCRIPTION

The embodiments described in the disclosure, and the configurations shown in the drawings, are only examples of embodiments, and various modifications may be made without departing from the scope and spirit of the disclosure.

It is to be understood that various embodiments of this document and terms used herein are not intended to limit technical features described in the present disclosure to specific embodiments, but include various modifications, equivalents, and substitutions of the corresponding embodiments. Throughout the accompanying drawings, similar or related components are denoted by similar reference numerals. A singular noun corresponding to an item is intended to include one or more of the items, unless a relevant context clearly indicates otherwise. In the present disclosure, an expression “A or B”, “at least one of A and B”, “at least one of A or B”, “A, B, or C”, “at least one of A, B, and C”, “at least one of A, B, or C”, or the like, may include any one of the items enumerated together or all possible combinations thereof. A term “and/or” includes a combination of a plurality of related items or any one of the plurality of related items. Terms such as “first”, “second”, or the like may be used simply to distinguish one element from another, and do not limit the corresponding components in any other respect (e.g., importance or order). In case that a component (for example, a first component) is mentioned to be “coupled with/to” or “connected to” another component (for example, a second component) with or without terms “operatively or communicatively”, it is to be understood that the component may be directly coupled to another component (e.g., in a wired manner), in a wireless manner, or through a third component). It should be further understood that terms “include”, “have” or the like, used herein indicate the presence of features, numerals, steps, operations, components, parts mentioned herein, or combinations thereof, and do not preclude the presence or addition of one or more other features, numerals, steps, operations, components, parts, or combinations thereof. In that a component is referred to as being “connected”, “coupled”, “supported”, or “in contact” with another component, it includes not only a case where the components are directly connected, coupled, supported, or in contact with each other, but also a case where the components are indirectly connected, coupled, supported, or in contact with each other through a third component. In case that a component is referred to be disposed “on” another component, it includes not only a case where the component is in contact with another component, but also a case where still another component exists between the two components.

Hereinafter, a robot cleaner according to various embodiments is described in detail with reference to the attached drawings.

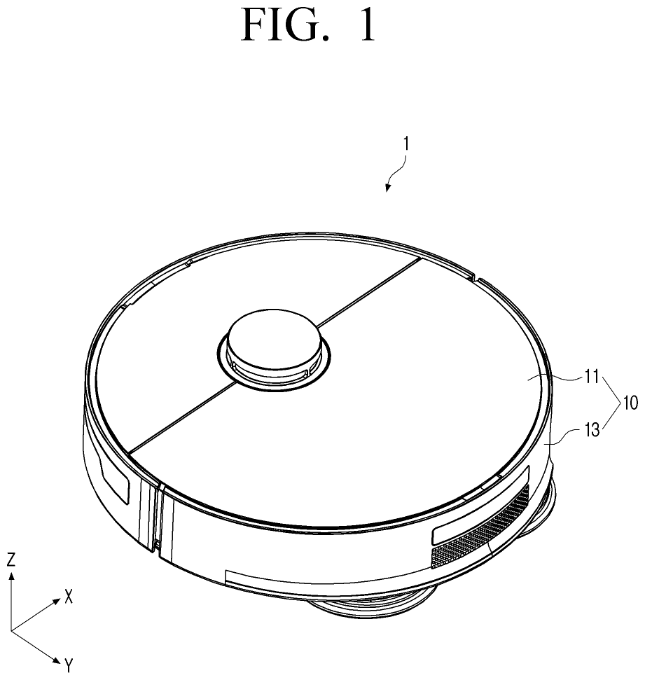

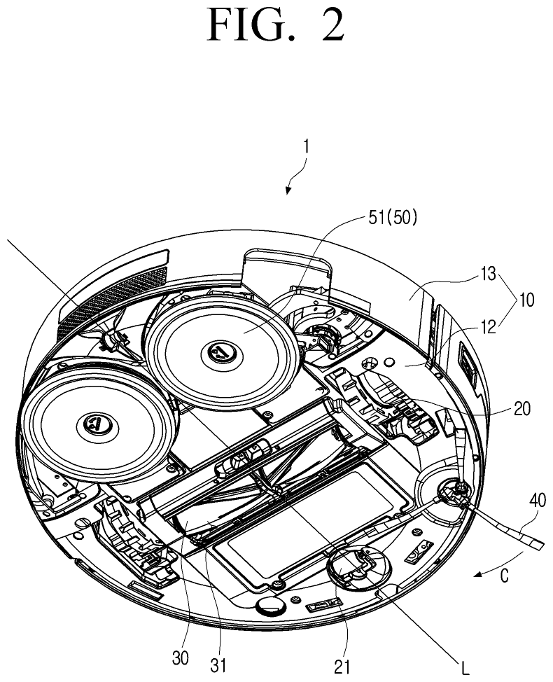

FIG. 1 is a perspective view of the robot cleaner according to one or more embodiments. Referring to FIG. 1, a main body 10 of a robot cleaner 1 may have a circular shape. In detail, the main body 10 may have a disk shape. The main body 10 may include an upper housing 11, a lower housing 12 (see FIG. 2), and a side housing 13 that form an exterior.

The upper housing 11 may form one surface of the main body 10 that faces an opposite direction (Z) from ground. The upper housing 11 may include a display device, an operation button, or the like for a user to control an operation of the robot cleaner 1, and may include various sensors such as a a light detection and ranging (LiDAR) sensor.

The lower housing 12 may form one surface of the main body 10 that faces the ground by opposing the upper housing 11. The upper housing 11 and the lower housing 12 may have corresponding circular shapes.

The side housing 13 may connect the upper housing 11 and the lower housing 12 to each other, and forms a side surface of the main body 10. The side housing 13 may be integrated with the upper housing 11 or the lower housing 12, or may be provided as a separate member.

As the main body 10 of the robot cleaner 1 has the circular shape formed by the housings 11, 12, and 13, the robot cleaner 1 may have a degree of freedom regarding a turning radius in case of traveling to perform cleaning. For example, in case that the robot cleaner 1 travels to clean a square space, the robot cleaner 1 may pass an angled part by only changing a travel direction without having to go backwards if changing a travel path at the angled part.

FIG. 2 is a bottom view of the robot cleaner according to one or more embodiments. Referring to FIG. 2, the robot cleaner 1 may include a driving wheel 20, a suction device 30, a brush 40, and a mopping device 50, disposed in a region of the lower housing 12.

The driving wheel 20 may be provided on the bottom of the main body 10 to move the main body 10. The bottom of the main body 10 refers to the region of the lower housing 12, and in detail, the driving wheel 20 may pass through the lower housing 12. One or more driving wheels 20 may be provided, and the present disclosure describes one or more embodiments where the pair of driving wheels 20 are provided as shown in FIG. 2.

The pair of driving wheels 20 may symmetric to each other based on a center line L of the main body 10. The driving wheel 20 may transfer a weight of the main body 10 to the ground, and may be rotated by receiving power generated by a traveling motor to thus move the robot cleaner 1 forward or backward.

In addition, the robot cleaner 1 may include an auxiliary wheel 21 for changing the travel direction of the main body 10. The auxiliary wheel 21 may be disposed on the center line L of the main body 10. Rotation of the auxiliary wheel 21 may be controlled by a processor 100. As the auxiliary wheel 21 is rotated, the travel direction of the robot cleaner 1 may be changed in case that the driving wheel 20 moves the robot cleaner 1 forward or backward.

The drawing shows one auxiliary wheel 21, and in some cases, the plurality of auxiliary wheels 21 may be provided.

Meanwhile, the travel direction of the robot cleaner 1 may not be changed by the auxiliary wheel 21, and the travel direction of the robot cleaner 1 may be changed by rotating the driving wheel 20 itself.

The suction device 30 may suction dust or dirt existing on the ground in the direction in which the robot cleaner 1 is traveling. The suction device 30 may include an intake port 31, a filter, a suction motor, a suction fan, and a suction vane.

The suction motor may rotate the suction fan at a high speed to make an air pressure in the suction vane lower than atmospheric pressure. The air pressure in the suction vane maybe lower than the atmospheric pressure, thus forming an airflow may from the outside of the main body 10 toward the suction vane. A speed of the airflow may be inversely proportional to the pressure in the suction vane.

In case that the suction motor is operated, external air may be sucked in from the outside of the main body 10 through the intake port 31, and dust or dirt around the intake port 31 may be suctioned during this process. The suctioned dust or dirt may be filtered by the filter.

The brush 40 may move dust or dirt accumulated or adhered to the ground toward the suction device 30. The brushes 40 may disposed on both sides of the main body 10 while being symmetric to each other based on the center line L of the main body 10.

The brush 40 may be rotated by receiving the power from a brushing motor. A rotation direction of the pair of brushes 40 may be a direction C from the outside of the main body 10 toward a central point of the main body 10.

As the brush 40 is rotated, dust or dirt that is strongly attached to the ground or entangled with each other may be separated from the ground or dispersed and flow toward the suction device 30. Accordingly, the suction device 30 may suction dust or dirt.

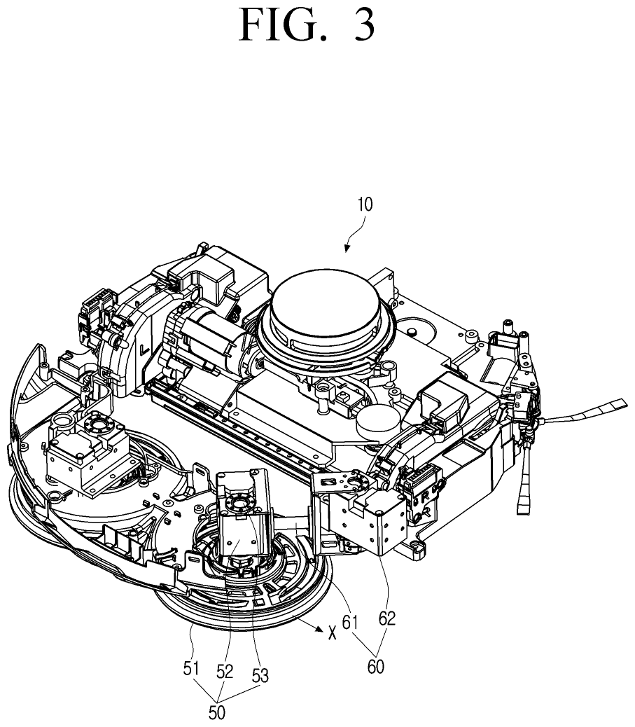

The mopping device 50 may performing wet cleaning on a zone to be cleaned. The mopping device 50 may include a mopping pad 51 and a second motor 52 (see FIG. 3). The mopping device 50 may also include a contact detection sensor or a distance detection sensor, which is described below.

The mopping pad 51 may have a circular shape. A mop or other cleaning member made of cotton may be attached to the mopping pad 51. The mopping pad 51 may having a protrusion to facilitate attachment of the cleaning member, and may further include a hole or tongs for inserting the cleaning member. The mopping pad 51 may receive moisture from a reservoir in the main body 10, and transfer the same to the cleaning member, or discharge the moisture forward in a movement direction of the cleaning member. The mopping pad 51 may be exposed outward from the bottom of the main body 10, for example, the lower housing 12.

The second motor 52 may rotate the mopping pad 51. The mopping pad 51 may be rotated by receiving the power from the second motor 52. A rotation direction of the mopping pad 51 may be a direction from the central point of the main body 10 toward the outside of the main body 10. The pair of mopping pads 51 may have the rotation directions opposite to each other.

As described above, the robot cleaner 1 may perform dry cleaning by the suction device 30 and the brush 40 for a zone in the travel path while traveling by the driving wheel 20, and simultaneously perform the wet cleaning by the mopping device 50.

FIG. 3 is a perspective view of the robot cleaner except for its housing according to one or more embodiments. Referring to FIG. 3, the robot cleaner 1 may include the mopping device 50 and a rotation device 60. Reference may also be made to the descriptions in reference to FIG. 2.

The second motor 52 of the mopping device 50 may be disposed above the mopping pad 51. The second motor 52 and the mopping pad 51 may be coupled to each other by a mopping shaft 53. For example, the mopping shaft 53 may have one end coupled with the second motor 52, and the other end coupled with the mopping pad 51. Accordingly, in case that the second motor 52 is rotated, the mopping shaft 53 may be rotated, and the mopping pad 51 connected to the mopping shaft 53 may also be rotated.

The rotation device 60 may rotate the mopping device 50. As an example, the rotation device 60 may rotate the mopping device 50 for the mopping device 50 to be moved to one of a first position where the mopping device 50 is disposed on the bottom of the main body 10 and a second position where the mopping device 50 protrudes outward from the main body or to any position between the first position and the second position. The rotation device 60 may have one region coupled to the inside of the main body 10 and another region coupled to the mopping device 50.

The rotation device 60 may include a bridge 61 and a first motor 62.

The bridge 61 may connect the mopping device 50 and the rotation device 60 to each other. The bridge 61 may include a monolithic rigid material. However, a configuration of the bridge 61 is not limited thereto, and may be formed by combining a plurality of components. The present disclosure describes one or more embodiments where the bridge 61 is formed by combining the plurality of components.

The first motor 62 may rotate the bridge 61. The bridge 61 may have one end coupled with the first motor 62, and the other end coupled with the mopping device 50.

As the first motor 62 is operated, the bridge 61 may be rotated by a predetermined angle. One end of the bridge 61 may be coupled with the first motor 62 and the other end of the bridge 61 may be coupled with the mopping device 50. Therefore, the mopping device 50 may be rotated in response to the rotation of the bridge 61. For example, the power from the first motor 62 may be transferred to the mopping device 50 by the bridge 61.

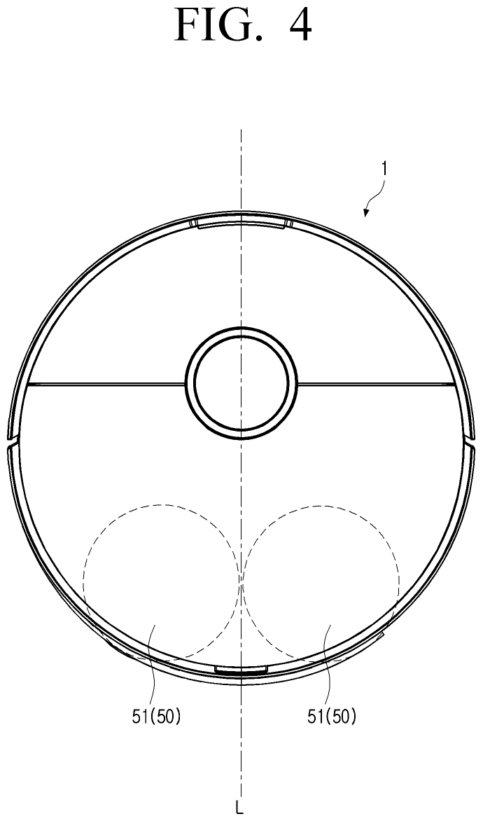

The rotation direction of the bridge 61 by the first motor 62 may be directed to the outside of the main body 10 from the inside of the main body 10. For example, the first motor 62 may rotate the mopping device 50 around the first motor 62 in an X direction. The rotation of the mopping device 50 is described in detail in the description provided below with reference to FIG. 4.

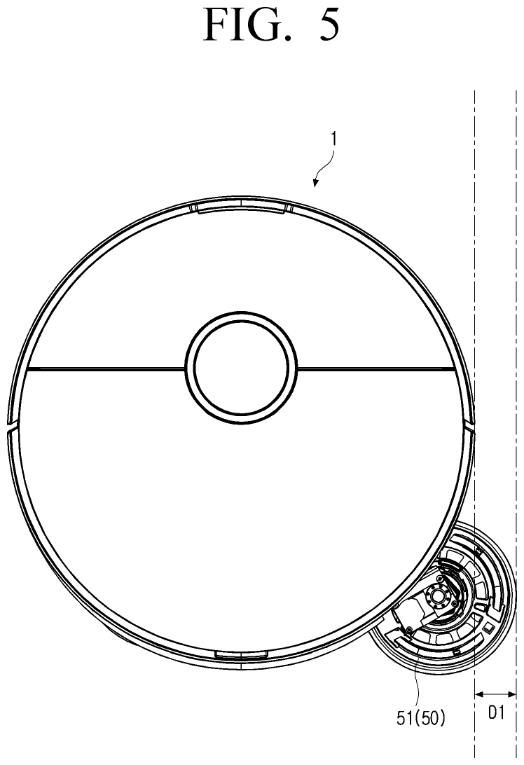

FIGS. 4 and 5 are views for explaining a position change of the mopping pad in the robot cleaner according to one or more embodiments.

Referring to FIG. 4, the mopping device 50 may be rotated to the first position for the mopping pad 51 to be disposed inside an outer diameter of the main body 10.

The first position refers to a position where the mopping pad 51 is disposed inside the outer diameter of the main body 10. For example, in case that the mopping device 50 is in the first position, the mopping pad 51 does not protrude outward beyond the outer diameter of the main body 10, and accordingly, a component other than the main body 10 may not collide with a surrounding object while the robot cleaner 1 travels and passes the surrounding object.

In case that the mopping device 50 is in the first position, the pair of mopping pads 51 may be disposed on both the sides of the main body while being symmetric to each other based on the center line L of the main body. Likewise, in case that the mopping device 50 is in the first position, the surrounding object not in contact with the outer diameter of the main body 10 on the travel path of the main body 10 and the mopping pad 51 may not collide with each other.

Meanwhile, in case that the mopping device 50 is in the first position, the robot cleaner 1 is unable to clean a space that the main body 10 is unable to enter, for example, a space where the floor and furniture are separated from each other such as a space below a cabinet.

Referring to FIG. 5, the mopping device 50 may be in the second position. The second position refers to a position where a portion of the mopping device 50, for example, the mopping pad 51, protrudes from the outer diameter of the main body 10 to the outside of the main body 10 within a predetermined range as the mopping device 50 is rotated.

The predetermined range of the second position refers to a range of a distance D1 (hereinafter, protrusion distance) from the outer diameter of the main body 10 to an outer diameter of the protruding mopping pad 51, which may be set in processes of designing and producing the robot cleaner 1. For example, the protrusion distance D1 may be up to 3 cm. For example, the second position of the mopping device 50 may be a position where the protrusion distance D1 is more than 0 cm and is 3 cm or less.

In case that the mopping device 50 is in the second position, the robot cleaner 1 may also clean the space that the main body 10 is unable to enter if the robot cleaner 1 travels to perform the cleaning. In detail the robot cleaner 1 may clean an area where the protruding mopping pad 51 passes along the travel path of the robot cleaner 1 based on the protrusion distance D1 of the mopping device 50.

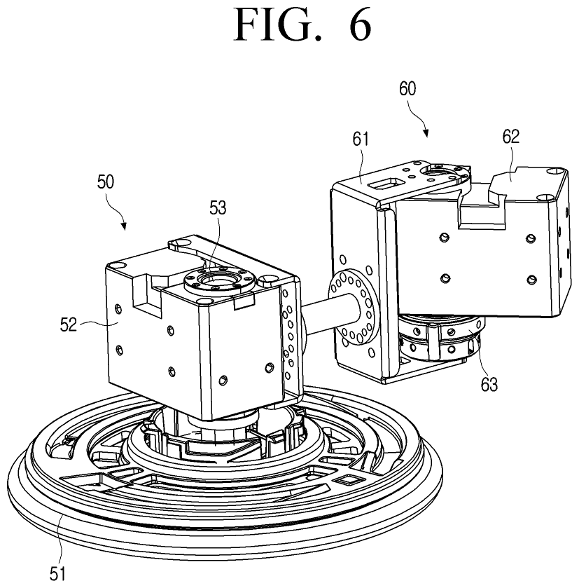

However, in case that the mopping device 50 is in the second position, there may be the surrounding object with which the mopping device 50 protruding by the protrusion distance D1 may collide although the mopping device 50 is not in contact with the outer diameter of the main body 10 or does not collide with the main body 10 on the travel path of the robot cleaner 1. In case that the protruding mopping device 50 collides with the surrounding object, the mopping device 50 and/or the rotation device 60 may be damaged based on an impact magnitude. To solve this problem, the robot cleaner 1 may include a passive joint 63 (see FIG. 6). The passive joint 63 is described in detail in the description provided below with reference to FIG. 6.

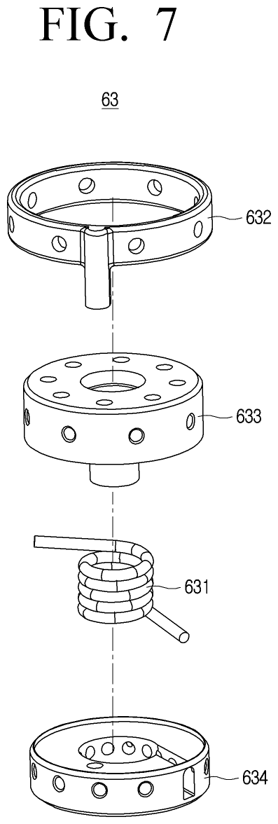

FIG. 6 is a view for explaining the passive joint of the robot cleaner according to one or more embodiments. FIG. 7 is an exploded perspective view of the passive joint of the robot cleaner according to one or more embodiments. Referring to FIGS. 6 and 7, the rotation device 60 of the robot cleaner 1 may include the passive joint 63.

The passive joint 63 may prevent damage to a component included in the mopping device 50 and/or the rotation device 60 in case that the mopping device 50 is in the second position and the mopping device 50 collides with the surrounding object.

In detail, the passive joint 63 may be disposed on the bridge 61 to change the position of the mopping device 50 based on a magnitude of an external force in case that the external force is applied to the mopping pad 51 while the mopping device 50 is moved to the second position, and return the mopping device 50 back to the second position in case that the external force disappears.

The passive joint 63 may include a torsion spring 631 and first to third bearings 632, 633, and 634. The torsion spring 631 refers to a spring wound for a coil to have a torsional stress of a predetermined intensity. The stress of the torsion spring 631 may be set during its manufacturing process. The stress of the torsion spring 631 may be determined by a K value of the spring. The first to third bearings 632, 633, and 634 may respectively be arranged on the upper part, lower part, and side part of the torsion spring 631. The passive joint 63 configured in this way may have one side coupled with the first motor 62 of the rotation device 60, and the other side coupled with the bridge 61 of the rotation device 60.

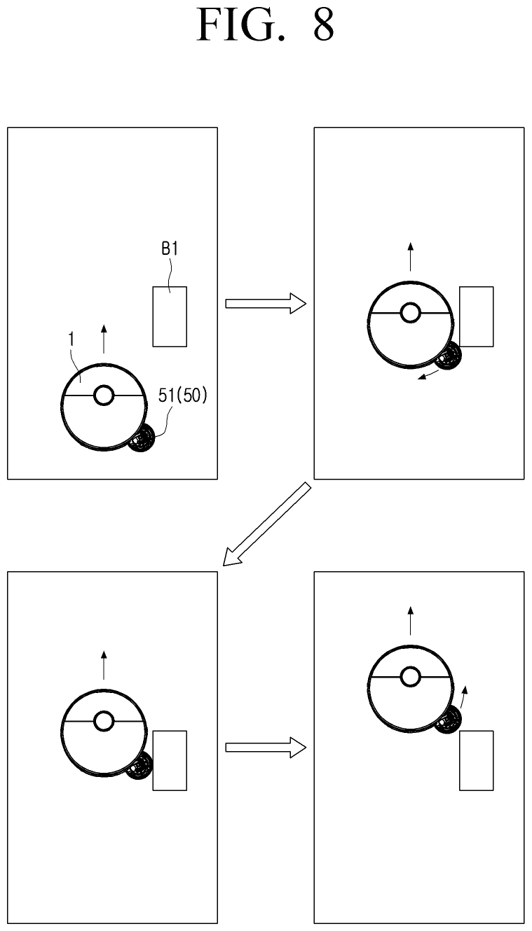

FIG. 8 is a view for explaining a position change of the mopping device by the passive joint of the robot cleaner according to one or more embodiments.

Referring to FIG. 8, in case that the mopping device 50 is moved to the second position by the rotation device 60, the mopping device 50 may maintain its position by the passive joint 63. In detail, the mopping device 50 may maintain the second position by the stress of the torsion spring 631.

In this way, the robot cleaner 1 may perform the cleaning while the mopping device 50 is disposed in the second position, and a surrounding object B1 and the mopping pad 51 may collide with each other on the travel path of the robot cleaner 1. In this case, the mopping pad 51 may receive the external force in a direction opposite to the travel path of the robot cleaner 1.

Here, the bridge 61 may be rotated by a corresponding angle as the torsion spring 631 of the passive joint 63 is wound. As the bridge 61 is rotated, each of the mopping device 50 and the mopping pad 51 may be rotated by an angle corresponding to the rotation angle of the bridge 61. The mopping device 50 may then return to the second position before the collision by the passive joint 63 in case that a process of the collision between the mopping pad 51 and the surrounding object B1 is completed as the main body 10 continuoulsy travels. For example, the passive joint 63 may move the mopping device 50 to the second position before collide by the stress of the torsion spring 631.

In detail, the torsion spring 631 may return to its state before the collision by the torsional stress, and as the torsion spring 631 returns, its rotation force may be transferred to the bridge 61 by the first to third bearings 632, 633, and 634. The bridge 61 may be rotated corresponding to a return movement of the torsion spring 631. The mopping device 50 coupled with the bridge 61 may be rotated by the angle corresponding to the rotation of the bridge 61, and return to the second position before the collision with the surrounding object B1.

As described above, the position of the mopping pad 51 may be flexibly changed by the passive joint 63 in case that the mopping device 50 of the robot cleaner 1 is moved to the second position where the mopping device 50 protruds from the main body 10, and the surrounding object B1 and the mopping pad 51 collide with each other while the robot cleaner 1 travels. Accordingly, the component included in the mopping device 50 and/or the rotation device 60 may not be damaged even though the protruding mopping device 50 collides with the surrounding object B1.

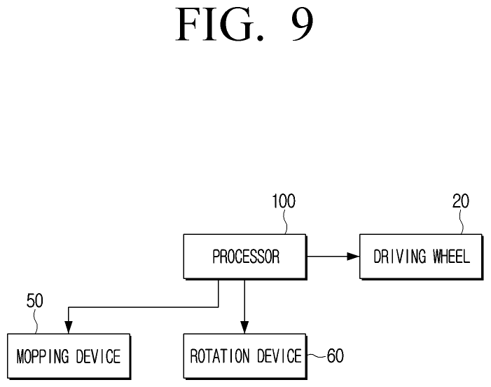

FIG. 9 is a block diagram for explaining a cleaning operation of the robot cleaner according to one or more embodiments.

Referring to FIG. 9, the robot cleaner may include a driving wheel 20, the mopping device 50, the rotation device 60, and the processor 100.

The processor 100 may control each component included in the robot cleaner 1.

The processor 100 may include at least one of a digital signal processor processing a digital signal, a micro processor, a central processing unit (CPU), a micro controller unit (MCU), a micro processing unit (MPU), a controller, an application processor, a graphics-processing unit (GPU), a communication processor (CP), or an advanced reduced instruction set computer (RISC) machine (ARM) processor, or may be defined by these terms. In addition, the processor 100 may be implemented in a system-on-chip (SoC) or a large scale integration (LSI), in which a processing algorithm is embedded, or may be implemented in the form of a field programmable gate array (FPGA). In addition, the processor 100 may perform various functions by executing computer executable instructions stored in a memory embedded in the processor or a memory provided separately in the robot cleaner 1.

The processor 100 may generate a map for a space where the robot cleaner 1 is disposed, and store the generated map in the memory. In detail the processor 100 may use a simultaneous localization and mapping (SLAM) algorithm to thus generate the map corresponding to the space where the robot cleaner 1 is disposed.

For example, to generate the map, the processor 100 may receive a sensing value of at least one sensor disposed in the robot cleaner 1 while the robot cleaner 1 travels, and may acquire an input distance to the surrounding object, the rotation angle and movement distance of the robot cleaner 1 based on the sensing value. The processor 100 may identify position information and generate a map based on the acquired information and the SLAM algorithm.

A spatial recognition sensor used to generate the map may be the LiDAR sensor, and a type of the sensor is not limited thereto. Various sensors may be disposed in the front or upper region of the main body 10.

The processor 100 may calculate the rotation angle of the robot cleaner 1 based on an angular speed of the robot cleaner 1 acquired from a gyro sensor, and calculate the moving distance of the robot cleaner 1 based on the rotation number of the driving wheel 20 that is acquired through an encoder. Next, the processor 100 may generate the map corresponding to the space from a reference position to an acquired position based on the distance between the robot cleaner 1 and the surrounding object that is acquired from the spatial recognition sensor while the robot cleaner 1 moves from the reference position to the acquired position. However, a method of generating the map by the processor 100 is not limited thereto.

The processor 100 may determine the travel path in the space based on the generated map, and perform the cleaning while moving the main body by controlling the driving wheel 20 based on the travel path. As the robot cleaner 1 performs the cleaning travel along the map, the spatial recognition sensor may continuously measure the distance to the surrounding object. Here, the spatial recognition sensor may measure a height of separation between the surrounding object and the ground or the floor. The robot cleaner 1 may perform the cleaning by traveling and entering the space While the mopping device 50 is disposed in the first position in case that the measured height is a height that the main body 10 may pass, for example, the measured height is higher than the upper maximum height of the main body 10. On the other hand, the processor 100 may control the first motor 62 to move the mopping device 50 to the second position in case that the measured height is a height that the main body 10 is unable to pass, and the mopping device 50 is able to pass. Information on the upper maximum height of the main body 10 or the upper maximum height of the mopping device 50 may be pre-measured and stored in the memory.

In detail, the processor 100 may drive the first motor 62 to thus rotate the bridge 61 to the outside of the main body 10 in case that the separation height between the surrounding object and the floor or the ground that is measured by the spatial recognition sensor is higher than a predetermined height that the mopping device 50 may pass. Accordingly, the mopping device 50 coupled with the bridge 61 may be moved to the second position. As the mopping device 50 is moved to the second position, the mopping pad 51 may protrude outward from the main body 10. The mopping pad 51, which protrudes outward from the main body 10, may enter a space below the surrounding object. The robot cleaner 1 may perform the cleaning travel while the mopping device 50 is moved to the second position, thereby cleaning the space below the surrounding object that the main body 10 is unable to enter. Meanwhile, the robot cleaner 1 may continuously perform the cleaning while the mopping device 50 is fixed to the first position, and may not clean the space below the surrounding object in case that the height between the surrounding object and the floor or the ground, measured by the spatial recognition sensor, is a height that the mopping device 50 is unable to pass.

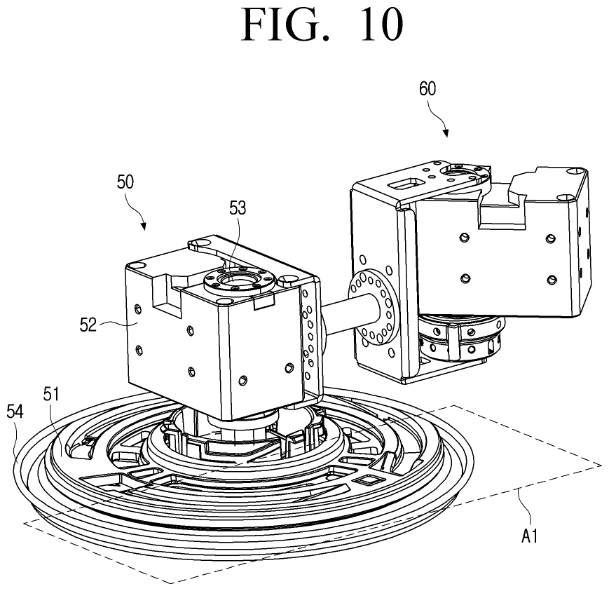

FIG. 10 is a view showing the contact detection sensor of the robot cleaner according to one or more embodiments. Referring to FIG. 10, the mopping device 50 may include a contact detection sensor 54. The contact detection sensor 54 may detect the collision between the surrounding object and the mopping pad 51 in case that the robot cleaner 1 travels while the mopping device 50 is disposed in the second position.

The contact detection sensor 54 may be a pressure detection sensor, and a type of the sensor is not limited thereto. For example, the contact detection sensor 54 may be implemented as a capacitive sensor detecting capacitance that is changed depending on its contact with the surrounding object.

The contact detection sensor 54 may be disposed along an outer circumference of the mopping pad 51 while being spaced apart from the outer circumference of the mopping pad 51. The contact detection sensor 54 may have a circular ring shape, and the contact detection sensor 54 may have a diameter larger than the diameter of the mopping pad 51.

Accordingly, the contact detection sensor 54 may collide with the surrounding object first before the mopping pad 51 directly collides with the surrounding object on the travel path of the main body 10 and receives the impact.

However, a shape of the contact detection sensor 54 is not limited thereto. For example, the contact detection sensor 54 may be disposed only in a front region A1 of the mopping pad 51. The robot cleaner 1 may perform the cleaning while moving the main body 10 forward, and the collision may only occur with the surrounding object that exists on the travel path of the main body 10 in its movement direction, unless the main body 10 moves backward. A manufacturing cost of the contact detection sensor 54 and a weight of the contact detection sensor 54 may be reduced, and the robot cleaner 1 may be lighter. The contact detection sensor 54 may be implemented as a plurality of sensors disposed at random intervals on the outer circumference of the mopping pad 51.

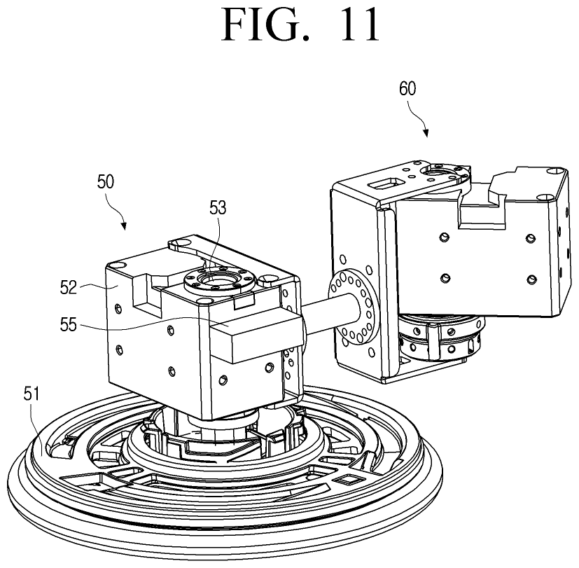

FIG. 11 is a view for explaining the distance detection sensor of the robot cleaner according to one or more embodiments. A distance detection sensor 55 may recognize the surrounding object of the robot cleaner 1. The distance detection sensor 55 may be disposed in a portion of the mopping device 50. FIG. 11 shows that the distance detection sensor 55 is disposed on one surface of the second motor 52 in the mopping devices 50, which is only an example, and a placement position of the distance detection sensor 55 may be changed in various ways.

The distance detection sensor 55 may be implemented in various ways, such as an ultrasonic sensor, an infra red (IR) sensor, an optical sensor, or an image sensor. In case of being implemented as the optical sensor, the distance detection sensor 55 may emit light, and detect the emitted light being reflected to the surrounding object, and then returning thereto. In case that the distance detection sensor 55 detects reflected light, the processor 100 may acquire information on the distance between the robot cleaner 1 and the surrounding object based on a difference between emission time and detection time.

In case that the distance detection sensor 55 is implemented as the image sensor, the processor 100 may analyze a plurality of image frames continuously acquired by the distance detection sensor 55, identify a size change of the surrounding object in the image frame, and acquire the distance between the robot cleaner 1 and the surrounding object based on the size change.

Meanwhile, the robot cleaner 1 may include both the distance detection sensor 55 of this type and the contact detection sensor 54. In some cases, the plurality of contact detection sensors 54 and the plurality of distance detection sensors 55 may respectively be provided.

In this case, the processor 100 may control the rotation device 60 to move the mopping device 50 back to the second position before the collision if the mopping device 50 is at a distance where the mopping device 50 does not collide with the surrounding object even though the mopping device 50 is in the second position before the collision, in case that the contact detection sensor 54 detects the collision between the surrounding object and the mopping pad 51, the mopping device 50 is moved by the processor 100 to the second position or the first position where the mopping device 50 is not in contact with the surrounding object, and the distance detection sensor 55 then measures the distance from the main body 10 to the surrounding object.

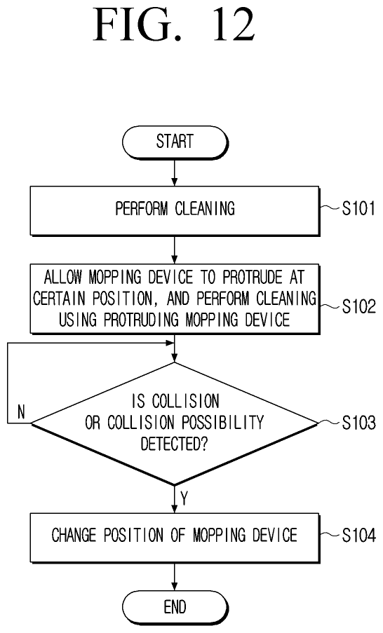

FIG. 12 is a flow chart for explaining a method for controlling a robot cleaner according to at least one embodiment of the present disclosure.

Referring to FIG. 12, the robot cleaner may perform the cleaning by traveling in the space where the robot cleaner is disposed while the mopping device is disposed on the bottom of the main body in the robot cleaner, for example, disposed in the first position (S101). The robot cleaner may then rotate the mopping device to protrude outward from the main body (to be disposed in the second position), and perform the cleaning using the protruding mopping device in case that the robot cleaner reaches a certain position in the space where the robot cleaner is disposed (S102).

The certain position refers to a space where the main body is unable to pass, and the mopping device or the mopping pad is able to pass. For example, the certain position may be a space where a height from the ground or the floor to a bottom surface of the surrounding object is lower than the height of the main body and higher than the height of the mopping device or the mopping pad 51.

The robot cleaner may then move the mopping device to be lower than the main body (S104) in case of detecting the collision between the surrounding object and the mopping pad based on the sensing value of the contact detection sensor disposed in the mopping device, or detecting collision probability between the surrounding object and the mopping pad based on the sensing value of the sensor disposed in the mopping device (S103).

In detail, the robot cleaner may move the mopping device to a third position having a protrusion distance smaller than the second position before the collision. The robot cleaner may move the mopping device to the first position.

Meanwhile, as shown in FIG. 12, a method of detecting the collision or the collision probability may be performed based on the sensing value of the distance detection sensor disposed in the mopping device. For example, the robot cleaner may perform the cleaning by traveling the space where the robot cleaner is disposed while the mopping device is disposed on the bottom of the main body in the robot cleaner. The robot cleaner may then rotate the mopping device to protrude outward from the main body, and perform the cleaning using the protruding mopping device in case that the robot cleaner reaches the certain position in the space where the robot cleaner is disposed.

The robot cleaner may then detect the collision probability between the surrounding object and the mopping pad based on the sensing value of the distance detection sensor disposed in the mopping device. In case of detecting the collision probability, the robot cleaner may move the mopping device to be lower than the main body.

Here, the detecting of the collision probability may include measuring the height of the separation between the ground and the bottom surface of the surrounding object positioned on the path that the mopping device is to pass as the robot cleaner travels based on the sensing value of the distance detection sensor disposed in the mopping device.

The moving of the mopping device to be lower than the main body may include moving the mopping device to be lower than the main body in case that the measured height is within the predetermined range.

The predetermined range may be set considering a traveling speed of the robot cleaner and the height from the ground to the bottom surface of the surrounding object. For example, the robot cleaner may predetermine the separation distance between the ground and the bottom surface of the surrounding object positioned in front of the travel path of the robot cleaner, for example, the minimum value of time it takes for the robot cleaner to reach a region where the height from the ground to the bottom surface of the surrounding object is lower than the height of the mopping device.

In this way, the robot cleaner may move the mopping device to the first position in case of determining that a space below the surrounding object is gradually closed, for example, the space where the height from the ground to the bottom of the surrounding object is gradually lower based on the sensing value detected by the distance detection sensor.

For example, the robot cleaner may drive the first motor to thus rotate the mopping device or the mopping pad toward the first position, which is below the main body in case of expecting that the mopping device or the mopping pad is get caught in the closed region below the bottom of the surrounding object during its traveling.

Meanwhile, the separation space between the surrounding object and the floor or the ground may be a plurality of spaces having different heights. In this case, the robot cleaner may control the first motor to move the mopping device to either the first position or the second position based on the sensing value of the spatial recognition sensor or the distance detection sensor. For example, assuming that there is a first space whose height is lower than the height of the main body and higher than the height of the mopping device, and a second space whose height is lower than the height of the mopping device, the robot cleaner may move the mopping device to the second position and maintain the cleaning travel while the mopping device is disposed in the second position in case of performing the cleaning travel in the first space.

On the other hand, the robot cleaner may move the mopping device to the first position in case of performing the cleaning travel in the second space by passing the first space. The robot cleaner may perform the cleaning travel by maintaining the mopping device moved to the first position until the second space is closed. The robot cleaner may then move the mopping device to the second position again in case that there is a space having the same condition as the first space, and move the mopping device to the first position in case that the space is not the same as the first or second space.

Accordingly, in case of continuously performing the cleaning the space below the bottom of the plurality of objects having different heights, the robot cleaner may prevent the damage to the mopping device and/or the rotation device by causing the mopping device or the mopping pad to collide with the bottom of the surrounding object.

Meanwhile, an error may occur in data on the space below the surrounding object that is detected by the spatial recognition sensor. The spatial recognition sensor may be disposed in a front region of the main body. Therefore, a viewing angle of the spatial recognition sensor may be smaller than a viewing angle of the distance detection sensor disposed in the mopping device of the main body. For example, a distance from the main body to the surrounding object that is measured by the spatial recognition sensor may be different from an actual distance from the outer diameter of the mopping device or the mopping pad to the surrounding object. In this case, the mopping device and the surrounding object may collide with each other in case that the robot cleaner travels while moving the mopping device to the second position based on the distance information measured by the spatial recognition sensor.

To solve the above-mentioned problem, the robot cleaner may control the position of the mopping device based on the sensing value detected by the distance detection sensor. The distance detection sensor may measure the distance from the surrounding object positioned on the travel path of the robot cleaner in the travel direction to the outer circumference of the mopping pad. The robot cleaner may control the first motor to rotate the mopping device toward the first position in case that the distance measured by the distance detection sensor is within the predetermined range. Here, the predetermined range may be a setting for a result value acquired in case that the distance measured by the distance detection sensor is divided by the traveling speed of the robot cleaner. For example, assuming that the mopping device is set to move to the first position if the predetermined range is 6 seconds or less. Here, the result value may be 5 seconds in case that the distance measured from the mopping pad to the surrounding object is 50 cm and the robot cleaner travels at a speed of 10 cm per second. Therefore, the robot cleaner may move the mopping device to the first position. The predetermined range is not limited thereto, and may be predetermined during the process of designing and producing the robot cleaner, and the setting may also be changed later.

The above-mentioned problem may also occur in case that an error occurs in the height of the space below the surrounding object that is measured by the spatial recognition sensor. For example, the mopping device may collide with or get caught in the space below the surrounding object in case thon the bottom of the surrounding object has a space having a smaller height as the bottom slopes toward the inside of the space therebelow even though the space below the surrounding object is recognized by the spatial recognition sensor as the space having a height that the mopping device is able to pass.

To solve this problem, the robot cleaner may measure the separation height between the ground and the bottom surface of the surrounding object disposed on the path that the mopping device is to pass as the robot cleaner travels based on the sensing value of the distance detection sensor, and control the first motor to rotate the mopping device toward the first position in case that the measured height is within the predetermined range. Here, the predetermined range refers to a range for the height of the mopping device at a certain distance from the bottom surface of the surrounding object positioned in the travel direction of the robot cleaner. For example, assuming that the predetermined range where a height within 5 cm from the mopping device is set to of 10 cm, and the height of the mopping device is 9 cm, the robot cleaner may control the first motor to rotate the mopping device toward the first position in case that the separation height between the ground and the bottom surface of the surrounding object that is measured by the distance detection sensor is 9.5 cm and the distance from the corresponding point to the mopping device is 4 cm.

Accordingly, the mopping device may be prevented from colliding with the surrounding object or getting caught in the space below the surrounding object even in case that the sensing value detected by the spatial recognition sensor of the main body and the sensing value detected by the distance detection sensor are different from each other.

Meanwhile, the mopping pad may be positioned inside the outer diameter of the main body in case that the mopping device is in the first position. Therefore, the surrounding object outside the main body and the mopping pad may not collide with each other on the travel path in case that the robot cleaner performs the cleaning. Therefore, in case that the mopping device is in the first position, the damage to the mopping device due to the collision with the surrounding object may not occur even though information on the surrounding object is not detected by the distance detection sensor.

Meanwhile, the robot cleaner may activate the distance detection sensor in case that the mopping device is moved to the second position. For example, the robot cleaner may maintain the distance detection sensor to be deactivated in case that the mopping device is in the first position, and activate the distance detection sensor based on moving the mopping device to the second position.

In this way, the distance detection sensor may be turned on/off. Therefore, the robot cleaner may reduce its power usage by maintaining the distance detection sensor to be off in case that the detection of the surrounding object by the distance detection sensor is unnecessary, such as in case that the mopping device is in the first position.

The controlling method described with reference to FIG. 12 may be performed by the robot cleaner described with reference to FIGS. 1 through 11, is not necessarily limited thereto, and may be performed by the robot cleaner having a different configuration.

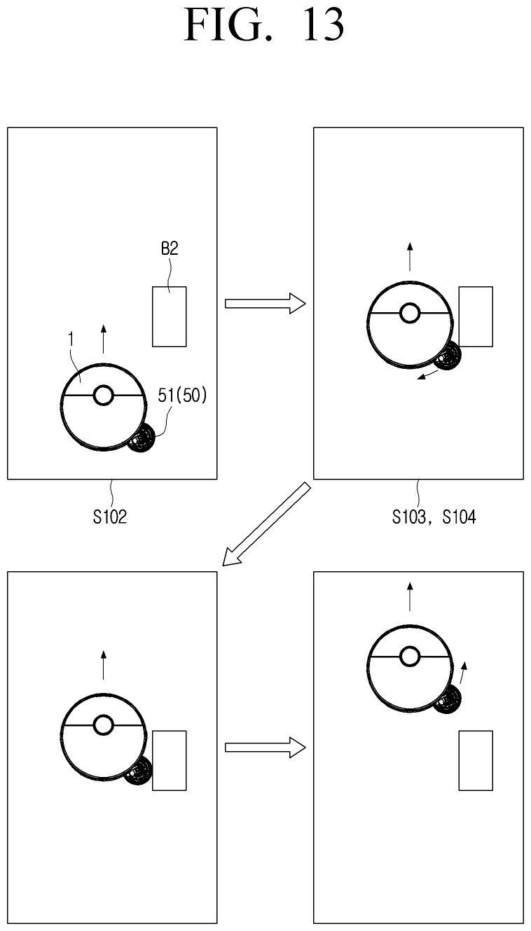

FIG. 13 is a view for explaining the position change of the mopping device by the contact detection sensor of the robot cleaner according to one or more embodiments.

Referring to FIG. 13, as the robot cleaner 1 travels, the processor 100 may move the mopping device 50 to be lower than the main body 10 in case that the contact detection sensor 54 and a surrounding object B2 collide with each other.

The processor 100 may then move the mopping device 50 back to its position before being moved in case of detecting that the surrounding object B2 is not in contact with the contact detection sensor 54.

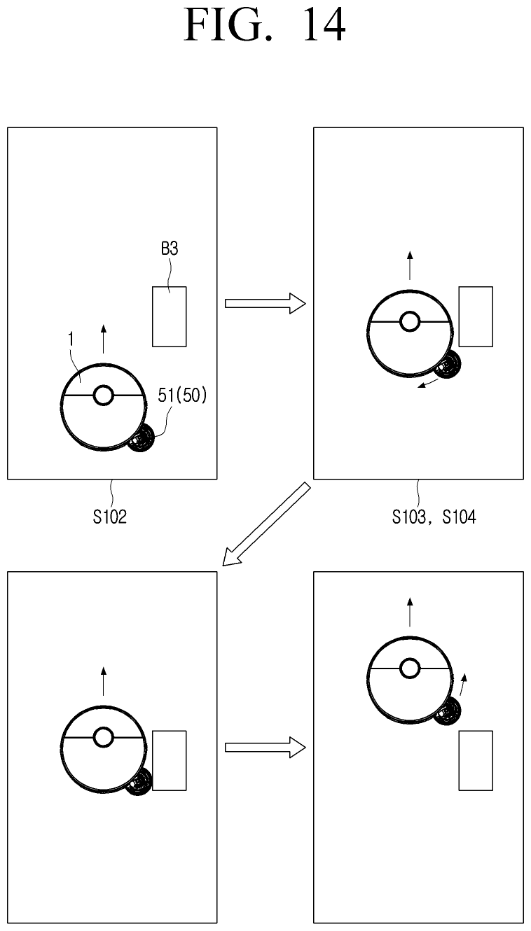

FIG. 14 is a view for explaining the position change of the mopping device by the distance detection sensor of the robot cleaner according to one or more embodiments.

Referring to FIG. 14, as the robot cleaner 1 travels, the processor 100 may move the mopping device 50 to be lower than the main body 10 in case that a distance between the mopping pad 51 and the surrounding object B3 reaches the predetermined range.

Accordingly, the protrusion distance by which the mopping device 50 protrudes from the main body 10 may be reduced. The distance by which the protrusion distance of the mopping device 50 is reduced may correspond to the minimum value to prevent collision between a closed region of the surrounding object B3 and the mopping device 50 or the mopping pad 51 as the robot cleaner 1 continuously travels. This value may be calculated by the processor 100 based on the traveling speed of the robot cleaner 1 and the distance to the closed region of the surrounding object B3.

The processor 100 may then move the mopping device 50 back to its position before being moved in case of determining that the robot cleaner 1 already passes the surrounding object B3 based on the value detected by the distance detection sensor 55 or the spatial recognition sensor.

The various embodiments of the present disclosure described above may be implemented by software including an instruction stored in a machine-readable storage medium (for example, a computer-readable storage medium). A machine may be a device that invokes the stored instruction from the storage medium, may be operated based on the invoked instruction, and may include the device according to the disclosed embodiments.

In detail, provided is a non-transitory readable storage medium storing software for sequentially performing the following processes: performing cleaning while the robot cleaner travels the space where the robot cleaner is disposed by disposing the mopping device on the bottom of the main body in the robot cleaner; rotating the mopping device to protrude outward from the main body of the robot cleaner and performing the cleaning using the protruding mopping device in case that the robot cleaner reaches the certain position in the space; and detecting collision or collision prediction between the surrounding object and the mopping device based on the sensing value of at least one sensor disposed in the mopping device, and changing the position of the mopping device based on a detection result.

A device equipped with such a non-transitory readable medium may perform the controlling method described in the various embodiments described above.

Here, the term “non-transitory” in the non-transitory readable storage medium may only indicate that the storage medium is tangible without including a signal, and does not distinguish whether the data are semi-permanently or temporarily stored in the storage medium.

A program for performing the method according to the various embodiments described above may be distributed online through an application store. In case of the online distribution, at least portions of a computer program product may be at least temporarily stored in a storage medium such as a memory of a server of a manufacturer, a server of an application store or a relay server, or be temporarily created.

Although the various embodiments of the present disclosure have been individually described hereinabove, each embodiment is not necessarily implemented alone, and may also be implemented so that the configurations and operations thereof are combined with those of one or more other embodiments.

In addition, although the embodiments are shown and described in the present disclosure as above, the present disclosure is not limited to the above-mentioned embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. A robot cleaner comprising:
a main body;
a driving wheel disposed on a bottom of the main body and configured to move the main body;
a mopping device disposed on the bottom of the main body; and
a rotation device comprising:
a bridge connected to the mopping device, and
a first motor configured to rotate the bridge for the mopping device such that the mopping device is moved to one from among a first position and a second position,
wherein the mopping device is disposed on the bottom of the main body based on the mopping device being in the first position, and the mopping device protrudes outward from the main body based on the mopping device being in the second position.

2. The robot cleaner as claimed in claim 1, wherein the mopping device comprises:
a mopping pad;
a second motor configured to rotate the mopping pad; and
at least one sensor, and
wherein the robot cleaner further comprises:
one or more processors; and
memory storing instructions, that when executed by the one or more processors, cause the robot cleaner to control the first motor to move the mopping device to one from among the first position and the second position based on a sensing value of the at least one sensor.

3. The robot cleaner as claimed in claim 2, wherein the main body has a circular shape,
wherein the mopping pad is disposed inside an outer diameter of the main body based on the mopping device being in the first position, and
wherein the mopping pad protrudes from the outer diameter of the main body to the outside of the main body within a predetermined range based on the mopping device being in the second position.

4. The robot cleaner as claimed in claim 2, wherein the rotation device further comprises a passive joint disposed on the bridge, and
wherein the one or more processors are configured to execute the instructions to cause the robot cleaner to:
change a position of the mopping device based on a magnitude of an external force being applied to the mopping pad while the mopping device is in the second position; and
return the mopping device to the second position based on the external force dissipating.

5. The robot cleaner as claimed in claim 2, wherein the at least one sensor comprises a contact detection sensor disposed along an outer circumference of the mopping pad, wherein the contact detection sensor is configured to detect contact between the mopping pad and a surrounding object, and
wherein a first diameter of the contact detection sensor is larger than a second diameter of the mopping pad.

6. The robot cleaner as claimed in claim 2, wherein the at least one sensor comprises a distance detection sensor configured to recognize a surrounding object.

7. The robot cleaner as claimed in claim 6, wherein the one or more processors are configured to execute the instructions to cause the robot cleaner to activate the distance detection sensor based on the mopping device being moved to the second position.

8. The robot cleaner as claimed in claim 6, wherein the one or more processors are configured to execute the instructions to cause the robot cleaner to:
determine, based on the mopping device being in the second position, a measured distance from a first surrounding object positioned on a travel path of the robot cleaner in a travel direction of the robot cleaner to an outer circumference of the mopping pad based on a first sensing value of the distance detection sensor; and
control the first motor to rotate the mopping device toward the first position based on the measured distance being within a predetermined range.

9. The robot cleaner as claimed in claim 8, wherein the predetermined range comprises a predetermined duration range,
wherein the one or more processors are configured to execute the instructions to cause the robot cleaner to control the first motor to rotate the mopping device toward the first position based on a calculated duration being within the predetermined duration range, and
wherein the calculated duration is determined based on dividing the measured distance by a traveling speed of the robot cleaner.

10. The robot cleaner as claimed in claim 8, wherein the one or more processors are configured to execute the instructions to cause the robot cleaner to:
generate a map for a space where the robot cleaner is disposed based on at least one second sensing value of a spatial recognition sensor among the at least one sensor;
store the map in the memory; and
determine the travel path based on the generated map.

11. The robot cleaner as claimed in claim 10, wherein the one or more processors are configured to execute the instructions to cause the robot cleaner to generate the map based on simultaneous localization and mapping (SLAM).

12. The robot cleaner as claimed in claim 6, wherein the one or more processors are configured to execute the instructions to cause the robot cleaner to:
determine a measured separation height between the ground and a bottom surface of a first surrounding object disposed on a travel path of the mopping device based on a first sensing value of the distance detection sensor; and
control the first motor to rotate the mopping device toward the first position based on the measured separation height being within a predetermined range.

13. A method for controlling a robot cleaner which includes a mopping device, comprising:
performing cleaning based on the robot cleaner traveling through a space by disposing the mopping device on a bottom of a main body of the robot cleaner;
rotating the mopping device to protrude outward from the main body and performing the cleaning with the mopping device based on the robot cleaner reaching a determined position in the space; and
determining a detection result of a collision or a collision probability between a surrounding object and the mopping device based on a sensing value of at least one sensor disposed in the mopping device, and changing a position of the mopping device based on the detection result.

14. The method as claimed in claim 13, wherein the mopping device includes a mopping pad, a second motor configured to rotate the mopping pad, and the at least one sensor, the mopping device is connected to the main body by a rotation device, and the rotation device includes a bridge connected to the mopping device, and a first motor configured to rotate the bridge,
wherein in the performing the cleaning
comprises driving the first motor such that the mopping device protrudes outward from the main body.

15. The method as claimed in claim 13, wherein the determining the detection result comprises:
detecting the collision based on a first sensing value of a contact detection sensor among the at least one sensor; and
moving the mopping device to be lower than the main body based on the collision being detected.

16. The method as claimed in claim 13, wherein the determining the detection result comprises:
determining a detected distance between the surrounding object and the mopping device based on a first sensing value of a distance detection sensor among the at least one sensor; and
moving the mopping device to be lower than the main body based on a value of the detected distance being within a predetermined range.

17. The method as claimed in claim 13, wherein the determining the detection result comprises:
determining a measured separation height between the ground and a bottom surface of a first surrounding object disposed on a travel path of the mopping device based on a first sensing value of a distance detection sensor among the at least one sensor; and
moving the mopping device to be lower than the main body based on the measured separation height being within a predetermined range.

18. The method as claimed in claim 13, further comprising deactivating the at least one sensor based on the mopping device being disposed on the bottom of the main body, and activating the at least one sensor based on the mopping device protruding outward from the main body.

19. The method as claimed in claim 17, further comprising, based on the mopping device being moved to be lower than the main body, moving the mopping device to a prior position before being moved based on a calculated value indicating the robot cleaner has passed the first surrounding object,
wherein the calculated value is based on a second sensing value of the distance detection sensor or a third sensing value of a spatial recognition sensor among the at least one sensor.

20. A non-transitory computer-readable recording medium having instructions recorded thereon, that, when executed by one or more processors of a robot cleaner including a mopping device, cause the robot cleaner to:
perform cleaning based on the robot cleaner traveling through a space by disposing the mopping device on the bottom of a main body of the robot cleaner;
rotate the mopping device to protrude outward from the main body and performing the cleaning with the mopping device based on the robot cleaner reaching a determined position in the space; and
determine a detection result of a collision or a collision probability between a surrounding object and the mopping device based on a sensing value of at least one sensor disposed in the mopping device, and changing a position of the mopping device based on the detection result.
